(19) United States
(12) Patent Application Publication
(10) Pub. No.: US 2005/0233158 A1
(43) Pub. Date: Oct. 20, 2005

(54) Molecular electronic interconnects

(76) Inventors: James M. Tour, Bellaire, TX (US); Shawn M. Dirk, Albuquerque, NM (US)

Correspondence Address: ROBERT W STROZIER, P.L.L.C, PO BOX 429, BELLAIRE, TX, 77402-0429, US

(21) Appl. No.: 10/502,601

(22) PCT Filed: Jul. 26, 2002
(86) PCT No.: PCT/US02/23747

§ 371 Date: Jul. 26, 2004

Related U.S. Application Data
(60) Provisional application No. 60/308,218, filed on Jul. 27, 2001.

(51) Int. Cl. B32B 15/04; B32B 27/32

(52) U.S. Cl. 428/457; 428/500; 428/521

(57) ABSTRACT

An electrical interconnect device with contact(s) with improved resistance to oxidation, improved conductivity, and improved lubricity achieved by applying to the surface of the contact(s) a molecular coating chosen from the group consisting of monomers, oligomers, or polymers that are primarily organic in origin, capable of forming self-assembled monolayers or self-assembled multilayers, electrically conducting or non-conducting, and contain metal-binding ligands as pendant groups or as part of their backbone. Alternatively, the molecular contact coating may be a mat of chemically modified nanotubes.

### BACKGROUND OF THE INVENTION

Electrical interconnect devices may be constructed of one or of many electrically conducting metal contacts that function to connect electrical components. This is shown diagrammatically in FIG. 1 which depicts corresponding contact surfaces of a typical post-type device that, when interconnected, conducts electrical current between interdigitated electrically conducting metal contacts (between A and B) of the device. In order for the interconnect device to be useful, electrical conduction from one contact of the interconnect to the corresponding contact of the interconnect must be reliably achieved and dependably maintained.

When physical conditions impede or prevent physical touching between the metal contacts, failures of such devices can occur. For example, as the dimensions of the interconnects are made smaller, surface roughness in the contact surfaces can make it difficult to achieve or maintain sufficient physical touching between contacts to ensure proper electrical conduction. As the dimensions of the interconnect device become so small that the surface topology of the contact surfaces on the nanoscale begins to appear as mountains, large portions of the corresponding surfaces of the contacts may not be able to touch. These gaps substantially increase the electrical resistance in the interconnect device and often result in an interconnect device that cannot adequately conduct electrical current. Such gaps on the nanometer scale may be illustrated as in FIG. 2, in which the surface roughness of the post and socket of the device of FIG. 1 are depicted diagrammatically. This diagrammatic representation illustrates why the provision of electrical interconnects for nanoscale applications is a particularly challenging problem.

Another cause of electrical contact failure arises from chemical or environmental agents. Examples of such chemical and environmental agents leading to contact failure are exposure to salt water, acid rain, pollution or ozone which react with the contact surfaces producing insulating layers. Other contact contaminating agents include sulfur trioxide, hydrogen chloride, and other oxidants that are industrial exposure products. These and other chemical agents generally degrade the contact surfaces via oxidation and other reactive processes, which produce undesirable coatings and may even cause the metal surface to flake off.

Oxide and other contaminant formation on the surfaces of a metal interconnect contact can interfere with proper functioning of the interconnect by interrupting the flow of current between the contracts. As coverage and thickness of oxides on the surfaces of either or both contacts of an interconnect grows, the ability of the interconnect to conduct current progressively decreases. While oxide and other contaminant coatings in some cases may be removed on insertion, many such coatings rapidly reform and interfere with the electrical connection. This problem is exacerbated in electrical interconnects for micronscale and nanoscale applications due to the very limited available contact surface area.

Since gold is an excellent electrical conductor and stable oxides do not form on gold surfaces, contact surfaces of interconnects are often coated with gold to eliminate failures due to oxide layer formation. Gold coatings may be applied to metal contact surfaces in very thin layers by conventional electroplating, by electroless plating, or by vacuum deposition.

While gold does not form a stable oxide under ambient conditions, it does adsorb hydrocarbons that are often present in the surrounding atmosphere. The hydrocarbons can act as insulators between the contact surfaces, and this deleterious effect is exacerbated at smaller dimensions. Also, other metals can fuse through gold layers, causing metal oxidation and a decrease in conductivity. Other drawbacks of using gold are that it is expensive, and it is soft and therefore wears away relatively quickly on contacts that are repeatedly rubbed against each other, and the commonly used electroplating processes use environmentally costly cyanide reagents.

Contacts are sometimes made of Au/Ni/Cu alloys in lieu of coating base metal contacts with pure gold. In such Au/Ni/Cu contacts, the nickel serves as a diffusion barrier. Also, this alloy is harder than a layer of pure gold and therefore has markedly better wear resistance. These contacts are nevertheless inferior to gold or gold-coated contacts because they are less conductive than gold-coated contacts, and more difficult to make. Also the softness of pure gold can lend itself to larger contact areas between interconnect surfaces due to its enhanced deformation.

Other less desirable alternatives to gold contact coatings include the use of Ni/P alloy coatings, which typically are applied by electroplating. A small amount of this material produces a very rough brittle surface with a thin oxide layer. As such contacts are used, asperities snap off, exposing fresh unoxidized areas of the nickel surface for electrical interconnection. Unfortunately, this material does not age well, that is, the fresh areas readily reoxidize.

Sn/Pb alloy coatings are another alternative to the use of gold coatings. This material produces a surface oxide, which is removed upon insertion, exposing unoxidized portions of the contact surface for electrical interconnection. Unfortunately, the fretting corrosion produces a large amount of loose SnOₓ which can interfere with the overall operation of the interconnect device.

Yet another cause of electrical contact failure, particularly in nanoscale applications, is surface reconstruction, which is the migration of metal atoms vulnerable to oxidation from the substrate to the contact surface. Heating and vibration may give rise to problematic contact surface reconstruction.

In interconnection devices, the contact surfaces ideally make contact at three load-bearing points. Real surfaces elastically deform at these sites and other sites on the surface. The contact resistance may be represented by the formula R=Σᵢρ/2aᵢ where there are i contact points with area ai and resistivity p. If the number of contact points could be increased, the resistivity of the contact would be decreased (and therefore its conductivity increased).

The present invention addresses and solves these and other problems experienced in electrical interconnect devices particularly where overall device dimensions are in the micro-electronic and nano-electronic regime. But it must be stressed that this effect is also seen in larger interconnects that have millimeter- and centimeter-sized features.

It is therefore an object of this invention to provide electrical interconnect devices of improved resistance to failure due to degradation of the corresponding surfaces of the electrical contacts of the device by oxidation and other reactions with chemical agents.

It is a further object of this invention to provide electrical interconnect devices having contact surfaces with substantially reduced surface roughness and hence improved current conduction.

It is yet another object of this invention to provide electrical interconnect devices with contact surfaces that withstand repeated use without significant surface degradation, and in which the molecular layers provided in accordance with the invention act as contact surface lubricants.

Another object of this invention is to provide molecular contact coatings that stabilize the contact surfaces from surface reconstruction by making the surfaces more resilient and less prone to atom migration failures.

Still another object of this invention is to provide a method for improving conductivity and reliability of micro-electronic and nano-electronic as well as larger electrical interconnect devices.

Another object is to provide a molecular layer that acts as an active interconnect. In other words, it does more than respond merely as a wire which gives a linear response in current with increasing voltage. The molecular layer could be diodic in its behavior, thereby permitting current greater flow in one direction than in another. Or it could be switch-like, turning off or on only at a specified voltage. Or it could be negative differential resistance-like (NDR-like), where current can flow only at a specified voltage range, and not at a higher or lower voltage.

These and other objects and advantages of the present invention will be apparent from the description of the invention which follows below.

### SUMMARY OF THE INVENTION

We have found that the above and other objects may be achieved by applying molecular contact coatings to contact surfaces of interconnect devices in the form of self-assembled monolayers (SAMs) or multilayers of selected monomers, oligomers, and polymers, and in the form of mats of chemically modified nanotubes. The coatings may be applied to either one of two mating contact surfaces or to both mating contact surfaces. These molecular contact coatings modify the surfaces of the contacts of the interconnect devices to make them substantially less susceptible to the formation of insulating layers. They also reduce the roughness of the coated surfaces, minimizing or eliminating impediments to current conduction due to the rough surface topology of one or more touching contacts, they act as surface lubricants, and they improve electrical conductivity. Furthermore, molecular coatings can stabilize the surface of metal contacts from surface reconstruction, that is, the migration of metal atoms at or near the surface of the contacts. In many cases, these coatings cause the surface to be more resilient and less prone to atom migratory failure, by, for example, heating and vibration effects. Finally, some of these molecular coatings are diodic in its behavior or switch-like, or exhibit negative differential resistance.

Any monomer, oligomer, or polymer that is mainly organic in origin, capable of forming self-assembled monolayers or self-assembled multilayers, electrically conducting or non-conducting, and contains metal-binding ligands as pendant groups or as part of its backbone can be used as a molecular contact coating in the practice of this invention. This includes monomers, oligomers, and polymers containing as pendant groups or as part of their polymeric backbone, thiol, thioacetate (precursor to thiol), nitrile, amine, isonitrile, heterocycle, or diazonium salt. Non-conducting molecules can be used as electrical contact coatings because they are mechanically pushed from the metal-to-metal contact area upon mating of the contact surfaces, yet they surround the mating area and keep it free from oxidants or other surface contaminants. When the mating contact surfaces are disconnected, the molecules migrate to fill in the previous contact areas and thereby protect what would have been newly exposed metal.

One particularly important group of monomers that may be used to form a molecular contact coating is an oligo(phenyleneethynylene) compound of the following type: 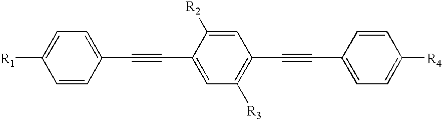
where R₁ and/or R₄, which serve to connect the device to a surface, are metal binding ligands (e.g., thiol, pyridine, nitrile, diazonium salt or amine) and R₂ and/or R₃, which serve to alter the electronic properties of the compound to change it from having a wire-like activity to having a device-like activity, are redox active groups (e.g., nitro groups). Switching activity can also be established when both R₂ and R₃ are non-redox active, such as H or alkyl (see: Donhauser, Z. J.; Mantooth, B. A.; Kelly, K. F.; Bumm, L. A.; Monnell, J. D.; Stapleton, J. J.; Price, D. W. Jr.; Rawlett, A. M.; Allara, D. L.; Tour, J. M.; Weiss, P. S. “Conductance Switching in Single Molecules Through Conformational Changes,” Science 2001, 292, 2303-2307.) Additionally, these monomers may be further modified by adding semiconducting or metallic nanoparticles, for example gold, to bind to the termini of the molecular wires and devices. These chemically modified metallic or semiconducting nanoparticles may be used in accordance with the invention as a conductive gap-filling media for the contact surfaces and to prevent oxidation.

### BRIEF DESCRIPTION OF THE DRAWINGS

These and other features, aspects, and advantages of the present invention will become better understood with reference to the following description, appended claims, and accompanying drawings where:

FIG. 1 is a diagrammatic representation of corresponding contact surfaces of a post-type interconnect device;

FIG. 2 is a diagrammatic representation of the surface topology on the micron or nanoscale of corresponding portions of contact surfaces of the post-type interconnect device of FIG. 1;

FIG. 3 is a diagrammatic representation of a self-assembled monolayer of oligo(phenyleneethynylene) compounds lining the socket contact of an interconnect device;

FIG. 4 is a plot of current versus voltage for a molecule with negative differential resistance electrical characteristics;

FIG. 5 is depiction of a closed interconnect device with both mating contacts bearing molecular contact coatings;

FIG. 6 is a representation of the adhesion of gold nanoparticles to the ends of molecular wires to help fill surface roughness canyons in the contact surface;

FIG. 7 is a representation of a chemically functionalized carbon nanotube adhered to one part of an interconnect surface, providing a “smooth” surface for electrical contact with the second part of the device; and

FIG. 8 is a representation of nanotube “whiskers” coating an interconnect contact surface via sidewall-bonded moieties.

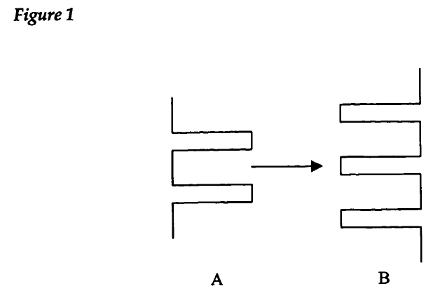

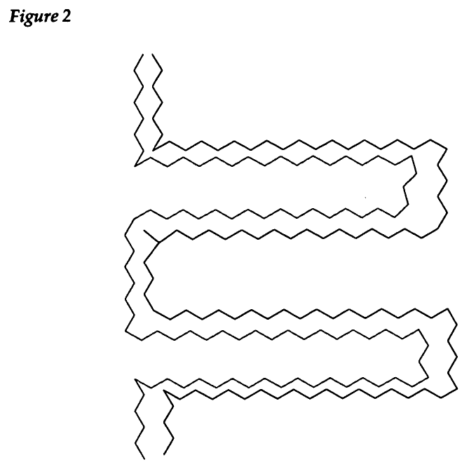

### DETAILED DESCRIPTION OF PREFERRED EMBODIMENTS OF THE INVENTION

The following groups of oligomers and polymers may be used in forming molecular contact layers in accordance with the practice of our invention: 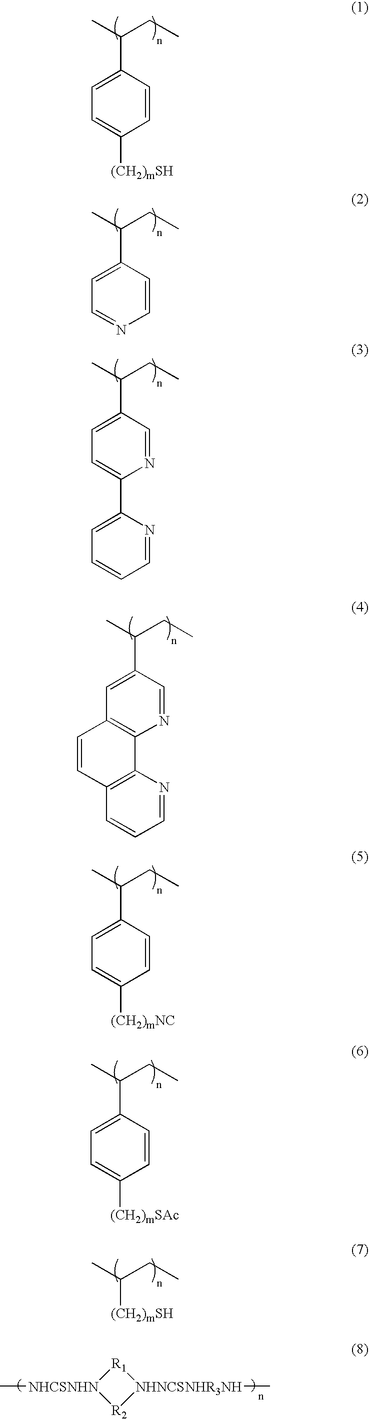 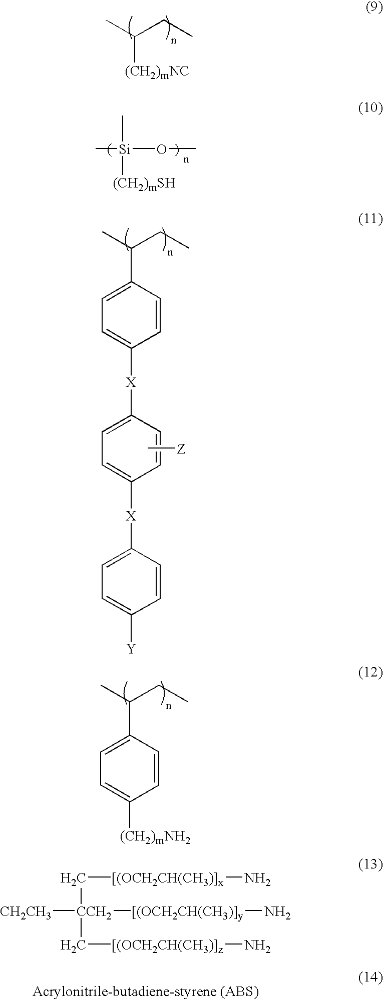
where:
X may be an alkynyl, alkenyl, alkyl, amine, ether, diazo, or thioether;
Z is a redox active group or groups, H, or alkyl;
Y is a metal ligand chosen from among thiol, thioacetate, nitrile, isonitrile; heterocycle, amine, or diazonium salt (in this case, dinitrogen is lost and there is a direct carbon-metal surface bond);
m may be 0-20;
n is the number of repeating units and will vary from 1 to about 10,000, preferably from about 10 to about 9,000, and most preferably from about 50 to about 1,000, so long as the molecular weight of the resulting molecule does not exceed about 1,000,000, and where the repeating units can be interspersed in a regular or random fashion with non-surface bonding repeat units such as CH₂CH₂ or CH(C₆H₅)CH₂ (in 1-7, 9, and 11-14), and Si(CH₃)₂O in (10);
R₁, R₂ and R₃ may be any organic moiety, but the hydrophobic moieties (e.g., methylene, ethylene, and phenylene) are preferred; and
x, y, and z may be from 1-20.

The above oligomers and polymers form self-assembling monolayers (SAMs) and multilayers that, unlike small molecule coverings of interconnects, tenaciously resist removal due to their multiple binding sites to the contact surfaces. Indeed, the multiple binding sites also serve to promote coverage of pinhole defects, which would not normally be well-covered by small molecules because of their inability to assemble over defects in the underlying metal.

The attachment is kinetically and thermodynamically very robust, particularly since the number of binding sites is multiplied by the number of surface bonding moieties that can reach the contact surface. In order for an oligomer or polymer to be removed from the contact surface, all points of attachment must removed and this would be a highly unlikely event. This robustness in terms of adhesion makes these oligomers and polymers ideal for application to interconnect contacts. These qualities also make the oligomers and polymers particularly well-suited for applications in which the interconnects are intended to be disconnected and reconnected numerous times.

A possible mechanism by which oxide formation is deterred by these molecular contact coatings involves the detachment of several sections of the molecules as one contact of the interconnect touches the other contact of the interconnect. The molecules may, depending on the repeat number n and the conformation of the molecule relative to the available surface binding sites, have hundreds of binding sites for attaching to the metal surfaces of the contacts, making the molecules very difficult to fully displace. Each bond to the contact surface has a strength of about 0.01 eV to 3 eV depending on the binding group and the metal surface. For example, for nitrile, the bond strength would be about 0.01 eV to about 0.10 eV for attachment to gold. The thiol attachment to gold is about 2 eV. When the interconnects are disconnected, it is believed that the polymer reseats or “reorganizes” itself on the previously exposed metal surfaces. This reorganization is also believed to seal the edges of the interconnect and the metal-to-metal mating surfaces while the contacts are connected, preventing air and other contaminants from reaching the exposed metal surface edges, and further prolonging the life of the interconnect by preventing oxidation at the edges of the contacts.

Once the interconnects are treated with the above oligomers and polymers, they also have the advantage of presenting a contact surface with a lubricity higher than present in untreated contacts, thereby reducing the rate of physical wear of the contact surfaces subject to repeated connection/disconnection cycles or long-term vibrations. It is expected that all or nearly all of the above-noted oligomers and polymers exhibit this lubricity property since the pendant moieties are hydrophobic and there is no H-bonding mechanism from which they can adhere to each other. These hydrophobic (lipophilic) interactions are very weak relative to dipolar and H-bonding interactions, and therefore the coatings do not “stick” to other surfaces.

Examples of contacts in which lubricity is important include sliding contacts in motors which are typically subject to substantial friction and wear that produces undesirable electrical noise. Lubricants often used on such contacts to reduce the wear (such as graphite and molybdenum disulfide) may have deleterious effects on conductivity because, inter alia, their surface coatings are much thicker than the coatings disclosed here, therefore they are not readily shifted away from the desired metal-to-metal mating contact areas. Other examples of contacts in which lubricity is important are make/break contacts such as are found in electrical relays. These are particularly subject to electrical and material breakdown.

The lubricity provided by the molecular contact coatings may also provide processing advantages in that the coated contacts will move through the manufacturing process with minimal friction. Also, it is far less expensive to dip the interconnect in a solution to permit self-assembly of the coating than to do electroplating, as required in forming gold coatings. Furthermore, these coatings avoid the cyanide used in gold electroplating which contributes to environmental and waste disposal costs. Finally, there are material cost factors. For example, on pin interconnects, the cost of the gold material (not including processing) is 10%-30% of the final cost of the interconnect. Indeed, if the amount of gold can be reduced or the gold eliminated altogether, the savings would be substantial. If the gold is eliminated altogether, then the electroplating process would not even be needed, thereby saving on labor, processing, and waste disposal costs.

When the molecular contact coatings are applied in larger pin interconnects, the molecules are believed to be mechanically pushed from the mating contact surfaces, thereby permitting optimal metal-to-metal contact for conduction. Also, the molecular layers will agglomerate around the junction points thus giving a high degree of atmospheric contaminant (oxygen or other reactants and hydrocarbons) buffer around the critical metal-to-metal contact point. Once the contact pins are removed from each other (they no longer touch), the molecular layers will migrate back into the now bare contact areas to once again protect the exposed metal surfaces. For these cases in general, and as for (1) to (13) above, the oligomers and polymers need not be conducting. Since almost all of the current is flowing through the mating metal-to-metal contact points, the oligomers and polymers are merely serving as protection from oxidation and contaminants, and not as a conduit for current.

Molecular contact coatings with the above-enumerated properties also comprise self-assembled monolayers of oligo(phenyleneethynylene) compounds of the following type: 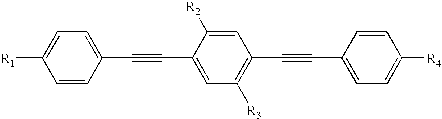
where R₁ and/or R₄, which serve to attach the monomers to a surface are metal binding ligands (e.g., thiol, pyridine, nitrile, or amine) and R₂ and/or R₃, which serve to alter the electronic properties of the compound to change it from having a wire-like activity to having a device-like activity, are redox active groups (e.g., nitro groups, see: Reed, M. A.; Chen, J.; Rawlett, A. M.; Price, D. W.; Tour, J. M. “Molecular Random Access Memories,” App. Phys. Lett. 2001, 78, 3735-3737, but they could also be H groups as the aryl backbone itself can cause non-linear conduction properties: see Donhauser, Z. J.; Mantooth, B. A.; Kelly, K. F.; Bumm, L. A.; Monnell, J. D.; Stapleton, J. J.; Price, D. W. Jr.; Rawlett, A. M.; Allara, D. L.; Tour, J. M.; Weiss, P. S “Conductance Switching in Single Molecules Through Conformational Changes,” Science 2001, 292, 2303-2307.).

A selection of these compounds that can be used in the practice of this invention is presented below. While most of the compounds shown provide for connection to only to the surface of the contact, similar compounds can be prepared that provide for attachment to two surfaces; e.g., where both R₁ and R₄ are not H. In this case, the other connection point serves as a point of contact for nanoparticles, as discussed below.

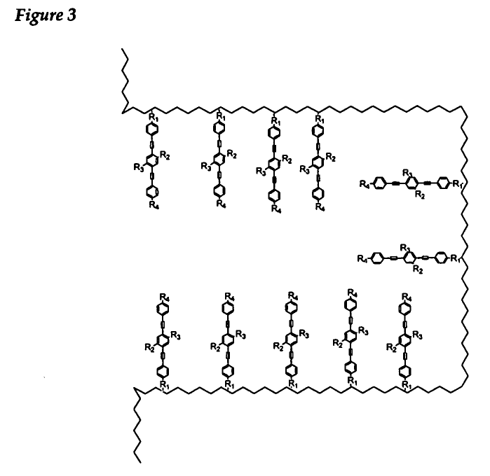

These types of compounds form SAMs on surfaces. Thus, immersion or incubation of, for example one mating contact of an interconnect device, in a solution or suspension of conductive oligo(phenyleneethynylene) compounds would result in formation of a SAM on the surface of the material, “lining the socket”, as shown in FIG. 3. Attachment to the surface of the contact (gold, palladium, platinum, etc.) will occur (via thiol, isonitrile, or diazonium with expulsion of nitrogen, etc.) and semi-conductor (SiO₂, via carboxylic or phosphonic acid, etc.) surfaces where SiO₂ reacts with acid groups in an acid catalyzed esterification type reaction. The SAM then provides a conductive, gap-filling connection when the mating contact touches the coated contact. The SAc moiety is cleaved in situ with acid (such as sulfuric acid) or base (such as ammonium hydroxide) to yield the free thiol (for the base cleavage, see: Tour, J. M.; Jones, L., II; Pearson, D. L.; Lamba, J. S.; Burgin, T. P.; Whitesides, G. W.; Allara, D. L.; Parikh, A. N.; Atre, S. “Self-Assembled Monolayers and Multilayers of Conjugated Thiols, α,ω-Dithiols, and Thioacetyl-Containing Adsorbates. Understanding Attachments Between Potential Molecular Wires and Gold Surfaces,” J. Am. Chem. Soc. 1995, 117, 9529-9534. For acid cleavage, see: Cai, Yao, Tour, Chem. Mater. 2002, in press).

It has been shown that the acetate can be cleaved, in situ, when exposed to a gold surface, without the use of acid or base, although the assembly is much slower. (See: Tour, J. M.; Jones, L., II; Pearson, D. L.; Lamba, J. S.; Burgin, T. P.; Whitesides, G. W.; Allara, D. L.; Parikh, A. N.; Atre, S. “Self-Assembled Monolayers and Multilayers of Conjugated Thiols, α,ω-Dithiols, and Thioacetyl-Containing Adsorbates. Understanding Attachments Between Potential Molecular Wires and Gold Surfaces,” J. Am. Chem. Soc. 1995, 117, 9529-9534).

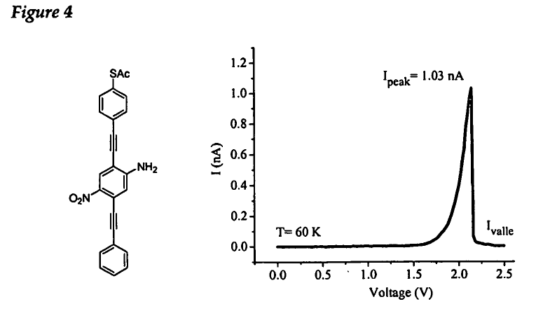

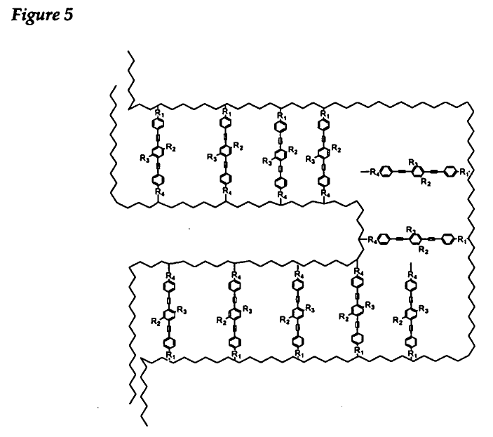

In the case of R₂=R₃=H or alkyl, the compounds sometimes act as simple conductors (see: Tour, J. M.; Rawlett, A. M.; Kozaki, M.; Yao, Y.; Jagessar, R. C.; Dirk, S. M.; Price, D. W.; Reed, M. A.; Zhou, C.-W.; Chen, J.; Wang, W.; Campbell, I. “Synthesis and Preliminary Testing of Molecular Wires and Devices,” Chem. Eur. J. 2001, 7, 5118-5134.), providing a passive connection between the two interconnect parts and other times as switching groups (see: Donhauser, Z. J.; Mantooth, B. A.; Kelly, K. F.; Bumm, L. A.; Monnell, J. D.; Stapleton, J. J.; Price, D. W. Jr.; Rawlett, A. M.; Allara, D. L.; Tour, J. M.; Weiss, P. S. “Conductance Switching in Single Molecules Through Conformational Changes,” Science 2001, 292, 2303-2307). In other cases, where R₁=R₂=—NO₂, or R₁=—NH₂, R₂=—NO₂, or where R₁ and R₂ are other redox active cores, the molecules can exhibit room-temperature negative differential resistance (NDR) (See: Tour, J. M.; Rawlett, A. M.; Kozaki, M.; Yao, Y.; Jagessar, R. C.; Dirk, S. M.; Price, D. W.; Reed, M. A.; Zhou, C.-W.; Chen, J.; Wang, W.; Campbell, I. “Synthesis and Preliminary Testing of Molecular Wires and Devices,” Chem. Eur. J. 2001, 7, 5118-5134.) The structure and current versus voltage plot for an NDR molecule when placed between gold electrodes is shown in FIG. 4. Because of this property, the NDR compounds provide an “active” connection between the two interconnect parts, with conductivity limited to a defined voltage region (see: Chen, J.; Wang, W.; Reed, M. A.; Rawlett, A. M.; Price, D. W.; Tour, J. M. “Room-Temperature Negative Differential Resistance in Nanoscale Molecular Junctions,” Appl. Phys. Lett. 2000, 77, 1224-1226).

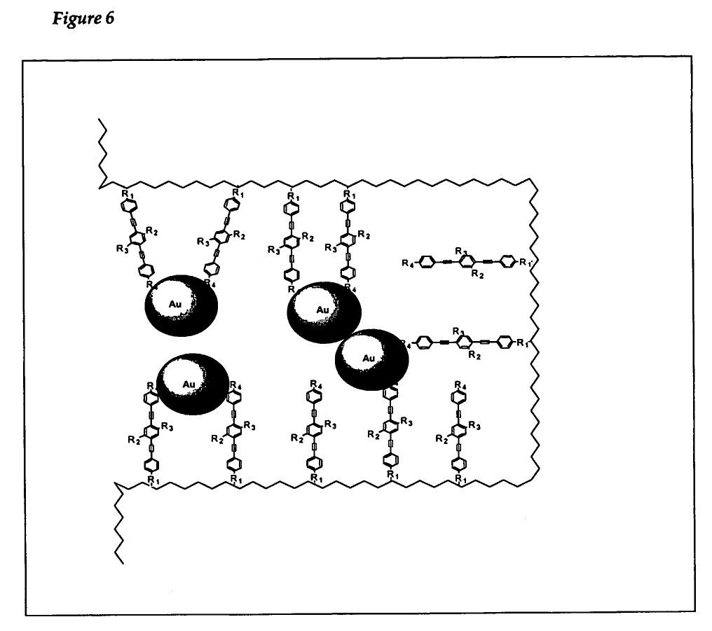

Of course, either one or both mating contacts may be coated, with the dual coating producing the best quality of electrical interconnection and protection. Either approach would serve to compensate for regions of poor contact caused by the surface roughness of the post material. A depiction of a closed interconnect device with both mating contacts bearing molecular contact coatings is shown in FIG. 5.

Of course, the monomers that can be used are not limited to oligo(phenyleneethynylene)s. Numerous classes of pi-conjugated compounds (with or without internal barriers based on heteroatoms, non-conjugated groups, or steric twist interactions for further device properties) can be used. For example, oligo(phenylenevinylene)s, oligo(thiopheneethynylene)s, oligo(phenyleneethenylene)s, oligo(thiopheneethenylene)s, oligo(arylene)s, oligo(aryleneethynylene)s, and oligo(aryleneethenylene)s, where arylene can be the disubstituted set from benzene, pyridine, thiophene, pyrazine, azabenzenes in general, naphthylene, bipyridines, and the like could be used (see: Tour, J. M. “Molecular Electronics. Synthesis and Testing of Components,” Acc. Chem. Res. 2000, 33, 791-804).

Semiconducting or metallic nanoparticles, for example gold, may be used to bind to the termini of the molecular wires and devices, as shown in FIG. 6. This further permits metal to infuse the system and provide a “tack-weld” as the mating connector is inserted to fill in the surface roughness gaps. This could also involve the use of metallic or semiconducting nanorods or fullerenes such as C₆₀ rather than nanoparticles. Adhesion of metallic nanoparticles or nanowires to the ends of the devices or wires would serve as further moieties to fill surface roughness canyons in the interconnects as illustrated in FIG. 6. Nanoparticles from about 2 nm to about 100 nm in diameter may be used to increase surface contact between the interconnect halves. The nanoparticles are attached to the surface via the bifunctionalized molecular wires. Moreover, if using the polymers or oligomers (1-14), the binding groups that project away from the contact surface would bind the nanoparticles or nanowires as well.

In a further embodiment of this invention, mats of chemically modified carbon nanotubes (single-walled=SWNT or multi-walled MWNT), as illustrated generally below, may be used as a gap-filling media for contact surfaces. Single-wall carbon nanotubes are highly conductive, are exceptionally stable, and are virtually defect free on a molecular scale, making them ideal for this application. Chemical modification of single-wall carbon nanotubes (SWNTs or MWNTs) can be achieved, for example, by reaction with aryl diazonium salts, resulting in modification of up to 1 in 20 carbons with functionalized phenyl moieties. (See: Bahr, J. L.; Tour, J. M. “Covalent Chemistry of Single-Wall Carbon Nanotubes—A Review,” J. Mater. Chem. 2002, 12, 1952-1958; Bahr, J. L.; Tour, J. M. “Highly Functionalized Carbon Nanotubes Using in Situ Generated Diazonium Compounds,” Chem. Mater. 2001, 13, 3823-3824; Bahr, J. L.; Yang, J.; Kosynkin, D. V.; Bronikowski, M. J.; Smalley, R. E.; Tour, J. M. “Functionalization of Carbon Nanotubes by Electrochemical Reduction of Aryl Diazonium Salts: A Bucky Paper Electrode,” J. Am. Chem. Soc. 2001, 123, 6536-6542). 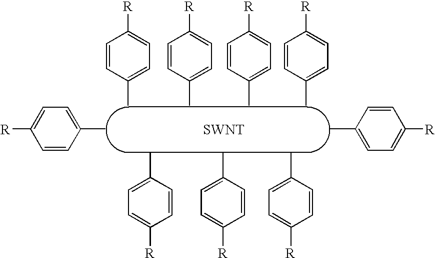
where R is —COOH, —OH, —NO₂, or —SH.

This type of material can be been prepared with a wide variety of functional groups including, for present purposes, at least some moieties that provide for attachment to surfaces by way of the R group ligand. For example, materials where R=COOH, —OH, —NO₂, or —SH can be used to treat contact surfaces. The covalent attachment is to both the sidewalls and the ends of the nanotubes, and the number of attached moieties can be varied by modification of the reaction conditions. In particular, for the present application, a lower degree of attachment may be desirable so that chemical modification would only marginally affect the nanotubes' electrical behavior. An additional advantage of the nanotubes is their size: several hundred nanometers to several microns in length being routine which is typically significantly greater than the gaps in the “rough” interconnect surface.

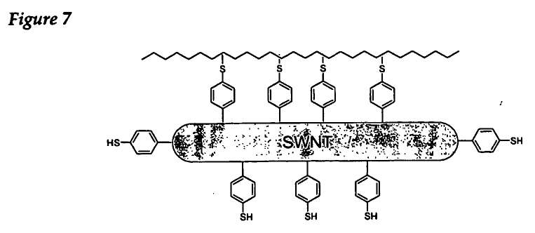

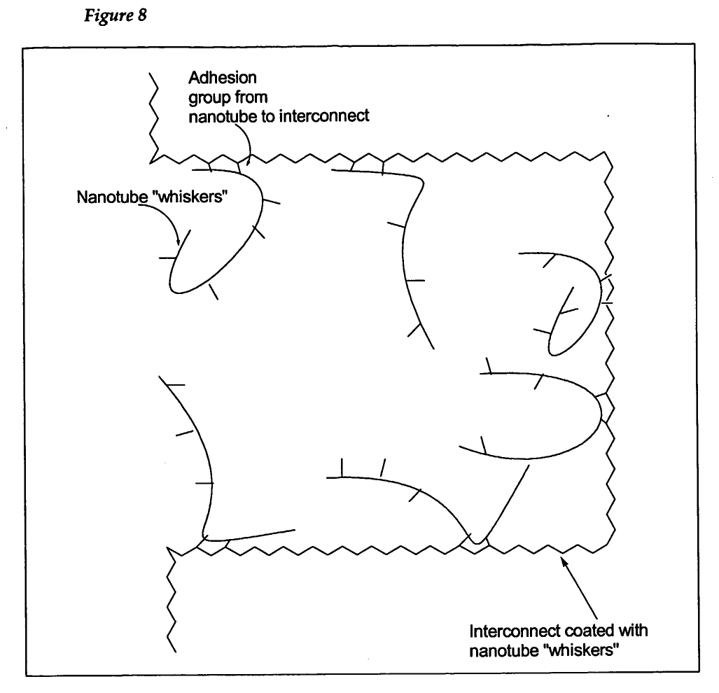

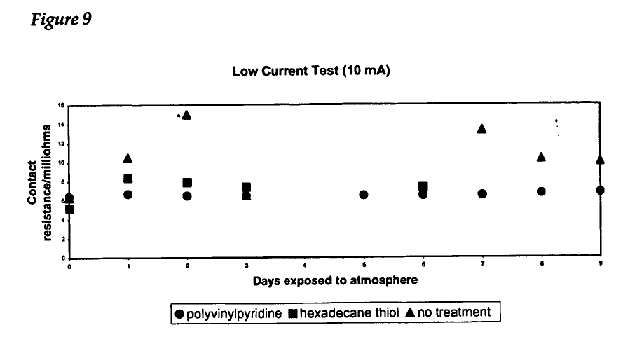

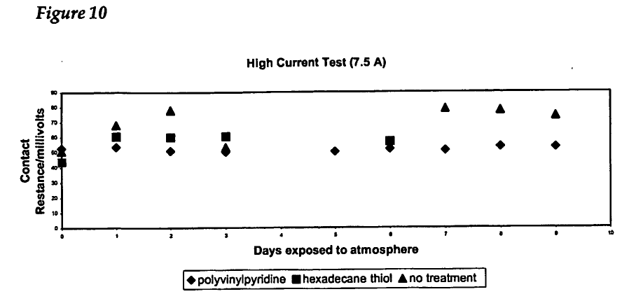

A chemically functionalized carbon nanotube adhered to one part of an interconnect surface providing a “smooth” surface for electrical contact with the second part of the device is depicted in FIG. 7. Nanotube “whiskers” coating the interconnect via sidewall-bonded moieties are shown in FIG. 8. As depicted there, the tubes are very long relative to the surface roughness of the interconnect.

Assembly of these functionalized nanotubes on the surface of an interconnect contact would effectively “smooth out” the roughness, providing a relatively consistent surface for interconnecting with the mating contact surface. If a more consistently “end-on” attachment of the nanotubes to the contact surface is desired, the nanotubes can be “cut” on their ends (by oxidizing to expose carboxylic acid groups (COOH)), and these open ends selectively functionalized with similar moieties that can be attached to surfaces. See Cai, Yao and Tour, Chem. Mater. 2002, in press.

The monomers, oligomers, polymers, and chemically modified carbon nanotubes useful in the practice of the present invention can be used to treat any conductive electronic contact surface. For example, the following contact surfaces may be treated: gold, palladium, platinum, copper, nickel, copper/zinc, copper/beryllium, silver and alloys therefrom using binding groups such as thiol, thioacetate (precursor to thiol), nitrile, amine, isonitrile, heterocycle, or diazonium salt.

The self-assembled monomers, oligomers, polymers, and carbon nanotubes may be applied to the contact surface by a self-assembly process wherein the contacts are run through a solution of the molecules, oligomers, or polymers or run through neat molecules, oligomers, or polymers. This can be a continuous or a batch process. Assembly can also be achieved electrochemically as described in U.S. patent application Ser. No. 10/090,211 filed Mar. 4, 2002, the disclosure of which is incorporated by reference. Monolayers, not multilayers are likely to form based on these methods. However, where it is desirable to prepare a multilayer to provide greater contact surface smoothing and protection, sequential bipolar absorption or electrochemical grafting can be used.

While the present invention will now be illustrated below by a series of examples, it should be understood that the protection of the invention is not meant to be limited by the details in these examples.

In the following examples 1-4, all copper/beryllium and copper/zinc interconnect contacts were degreased by immersing them in boiling chloroform for about 15 minutes. Any oxide layer present on the contacts was removed by soaking with 7 N nitric acid for about one minute. The interconnects were incubated overnight in ˜1 mmol solutions of the desired molecular component, rinsed with ethanol, blown dry with nitrogen, connected/disconnected 500 times, and evaluated. Low level measurements of 10 mA at 20 mV were made with a Keithly Instruments 2010 multimeter (also supplying current). Current was supplied for the high level test using a Xantrex XPD 18-30 series 500 W power supply and measured using the Keithly 2010 multimeter. Polymeric monolayer and monolayer height was determined using a Gaertner LSE stokes ellipsometer (model # 7109-C-351-REI).

### EXAMPLE 1

Polymer B referred to above was synthesized as follows. 4-Iodothioacetylbenzene A was coupled via a Stille coupling with vinyltributylstannane to provide 4-vinylthioacetylbenzene B. Although 4-vinylthioacetylbenzene may be polymerized using standard free radical initiated polymerization, in this case the polymerization was carried out at ambient temperature over one month in a closed vial.

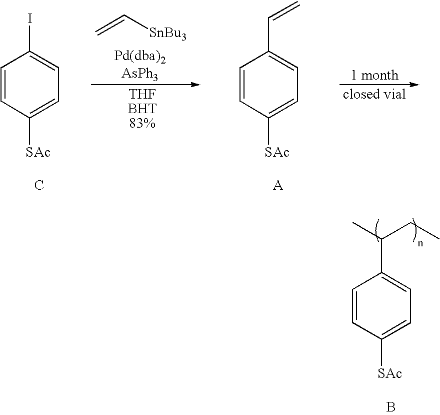

Initial self-assembly on gold interconnect contacts was done by dissolving the polymer in THF to 1 mmolar and dipping the interconnects in the solution for 12-24 h. A stable polymeric layer was formed measuring 4.20 nm in thickness, where the polymeric layer is defined as the thickness of the self-assembled polymer found on the surface. The thickness exceeds the width of the polymer's sulfur-to-methine proton distance because of the conformational flexing which can extend to the thickness of the radius of gyration. This layer is far thinner than would be achieved by painting or spin coating.

Since the polymer is attached to the surface via the sulfur atom, there are a preponderance of loops and chains projecting away from the surface as well as reactive end groups that may be further functionalized or help to establish contact with the other half of an interconnect. This may be enhanced by attaching gold nanoparticles to the thiols that project upwardly to give a further metallic layer. The above 4.20 nm and further gold nanoparticle layer were subjected to a pH 10 buffer treatment, was found to be more resistant to desorption than a monolayer comprised of cysteamine molecules with single points of attachment, thus establishing the stability and robustness of the layer.

### EXAMPLE 2

Another oligomer/polymer based on poly(4-vinylpyridine), Mₙ=60,000 that is available commercially from Aldrich Chemical Co. was self-assembled on a gold surface. The poly(4-vinylpyridine) formed a true monolayer having a height of about 0.70 nm, as determined ellipsometrically, consistent with the calculated height of the monomer. When the same polymer was assembled on a copper surface, the polymeric monolayer height was found to be 7.64 nm.

### EXAMPLE 3

Electrical conductivity experiments were performed on copper/beryllium and copper/zinc contacts treated with poly(4-vinylpyridine), Mₙ=60,000. The experiments proved the treated interconnects to be superior in maintaining electrical contact when compared to bare copper/beryllium and copper/zinc interconnects and copper/beryllium and copper/zinc contacts treated with a low molecular weight molecule, namely, hexandecane thiol. Hexandecane thiol was chosen because it often is the standard one used to protect surfaces in a SAM. The experimental results are summarized in FIG. 9.

In this example, the contact resistance was measured by passing 10 mA at 20 mV through the contacts via a Kelvin probe. The plot of FIG. 9 shows results for interconnects that have been disconnected and reconnected 500 times and allowed to incubate in a normal (23° C.) room atmosphere for nine days. Interconnects were deemed to fail if the contact resistance rose above 9 mΩ consistent with MIL-STD-1344A, and ASTM B 539-96.

### EXAMPLE 4

A high current contact resistance test was conducted on contacts prepared as described in Example 3 by passing 7.5 A at 1.5 V though an interconnect via a Kelvin probe. The resulting plot as seen in FIG. 10 shows results for interconnects that have been disconnected and reconnected 500 times and allowed to incubate at normal room atmosphere for nine days. The interconnect devices were deemed to fail if the contact resistance rose above 55 mV.

### EXAMPLE 5

The polymers numbered (1) to (14) above may be synthesized or obtained commercially as noted below.

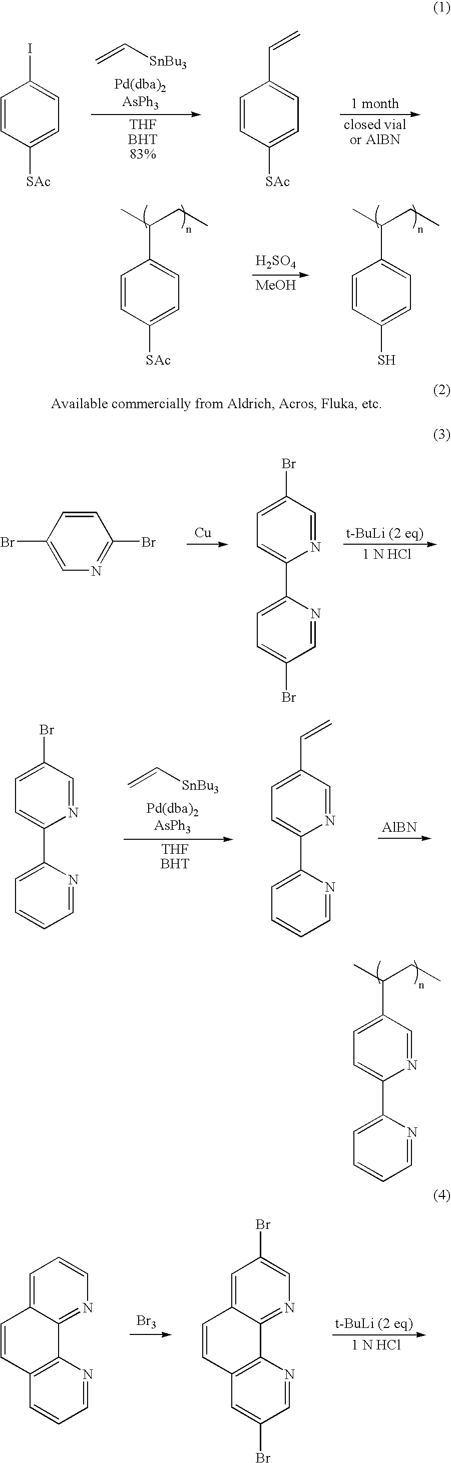

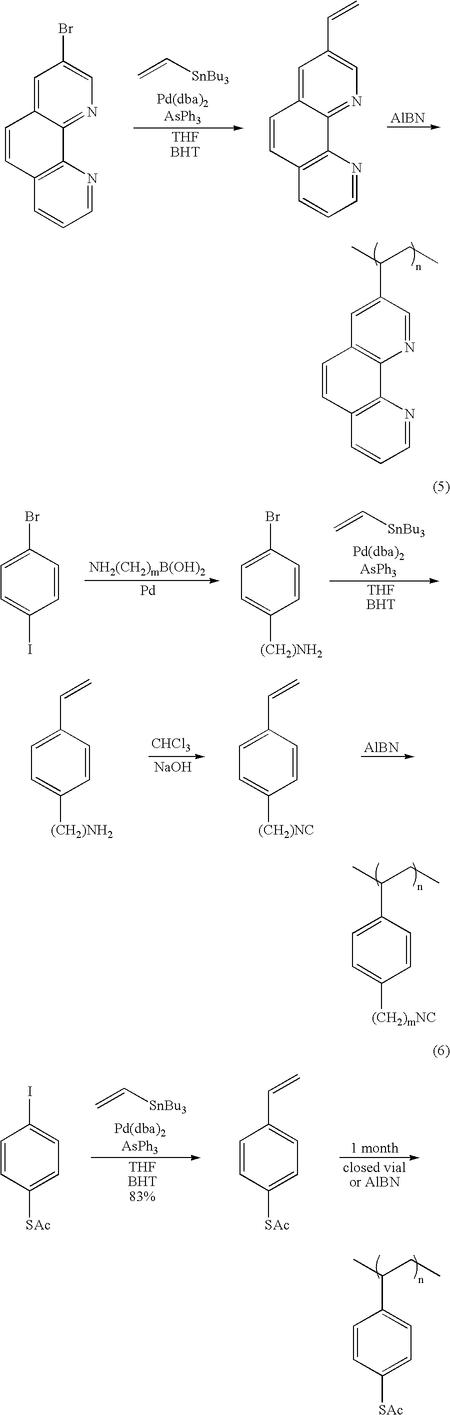

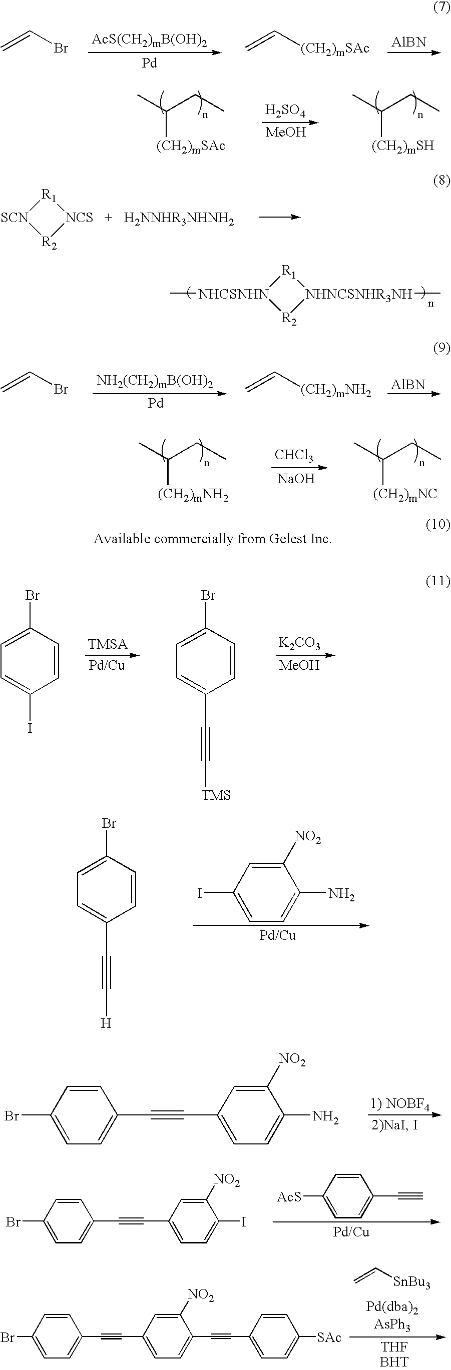

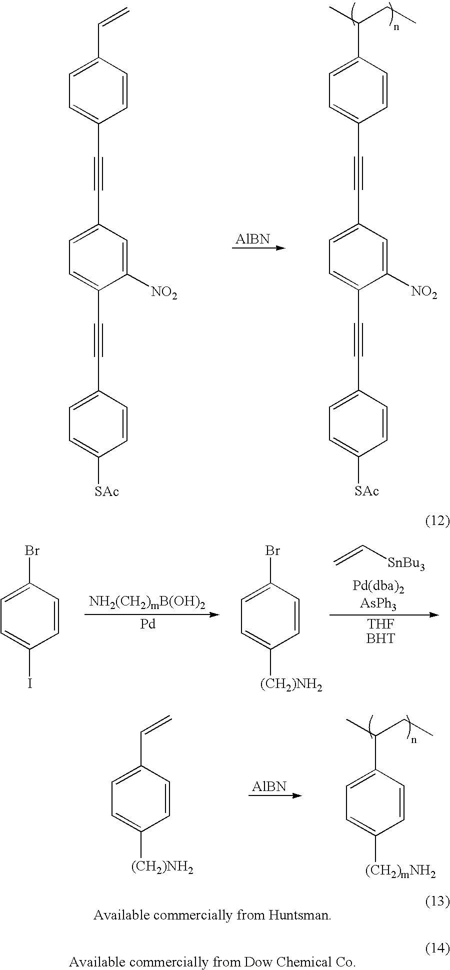

### EXAMPLE 5

As the contact angle increases, the surface becomes more hydrophobic. This is illustrated in the following table which gives contact-angle data for bare gold vs. selected modified surfaces.

| | CONTACT-ANGLE |
|---|---|
| SUBSTRATE | (DEGREES) |
| Bare gold (no cleaning) | 67 |
| Bare gold (cleaned with boiling chloroform) | 55 |
| Polyvinylpyridine | 50 |
| Siloxane | 115 |
| Hexadecane thiol | 67 |
| Poly(4-vinylbenzenethioacetate) | 65 |
| C₆₀/Cysteamine | 34 |

This data demonstrates that the molecular contact coatings of the invention are hydrophobic (except the C₆₀/Cysteamine) once bound to the metal surface of the contact. Because they are hydrophobic, they impart excellent protection against typically hydrophilic chemicals that may result in interconnect breakdown (particularly in the nanometer range) due to oxidation and other chemical reactions. Thus, for example, good protection is provided against common oxidants such as salt water spray, sulfur trioxide, hydrogen chloride, oxygen, and ozone which are hydrophilic.

While the present invention is described above in connection with preferred or illustrative embodiments, these embodiments are not intended to be exhaustive or limiting of the invention. Rather, the invention is intended to cover all alternative, modifications and equivalents included within its spirit and scope, as defined by the appended claims.

1. In an electrical interconnect device having at least one electrically conducting metal contact, the improvement comprising:
applying to the surface of the contact a molecular contact coating chosen from the group consisting of monomers, oligomers, or polymers that are organic or organometallic in origin, capable of forming self-assembled monolayers or self-assembled multilayers, electrically conducting or non-conducting, and contain metal-binding ligands as pendant groups or as part of their backbone.

2. The electrical interconnect device of claim 1 in which the monomers, oligomers, or polymers have other binding moieties that project generally away from the surface and nanoparticles or nanorods are bound to the generally away-projecting moieties.

3. The electrical interconnect device of claim 1 in which the monomers, oligomers, or polymers are conducting.

4. The electrical interconnect device of claim 1 in which the monomers, oligomers, or polymers are non-conducting.

5. In an electrical interconnect device having at least one electrically conducting metal contact, the improvement comprising:
applying to the surface of the contact a molecular contact coating of oligomers or polymers chosen from the group consisting of: 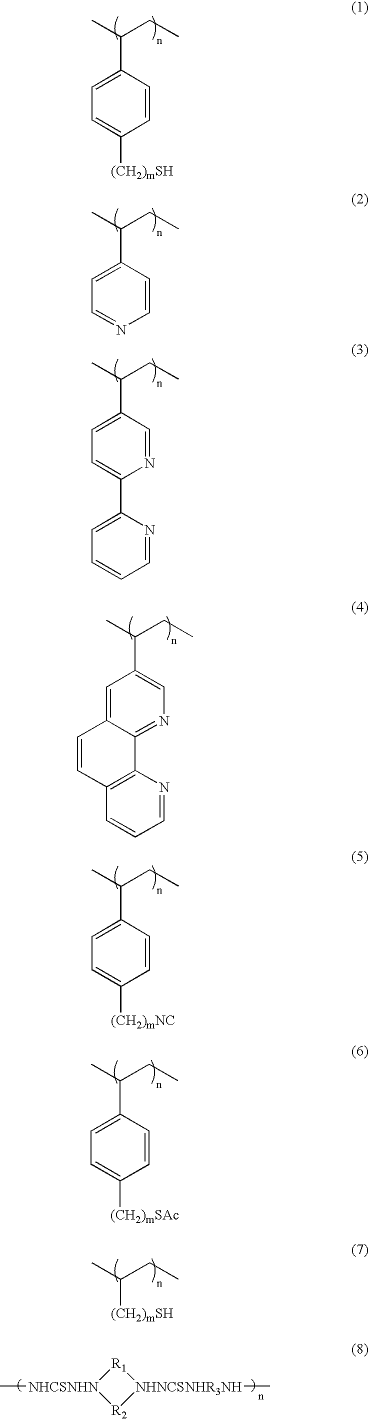 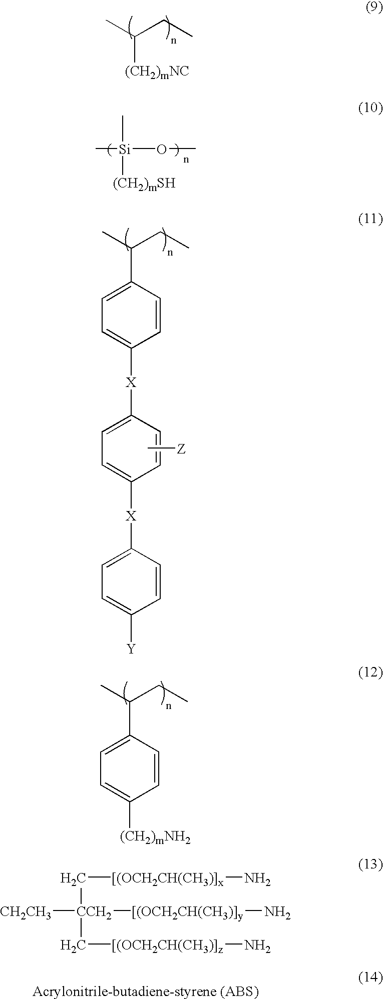
where:
X may be an alkyne, alkene, alkane, amine, ether, diazo, or thioether;
Z is a redox active group or groups;
Y is a metal ligand;
m is 0-20;
n is from 1 to about 10,000;
R₁, R₂ and R₃ may be any organic moiety; and
x, y, and z may be 1-20.

6. The interconnect device of claim 5 in which n is from about 10 to 9,000.

7. The interconnect device of claim 5 in which n is from about 50 to 1,000.

8. The interconnect device of claim 5 in which R₁, R₂ and R₃ are hydrophobic.

9. The interconnect device of claim 5 in which R₁, R₂ and R₃ are chosen from the group consisting of methylene, ethylene, and phenylene.

10. The interconnect device of claim 5 in which Y is thiol, thioacetate, nitrile, isonitrile; heterocycle, amine, or diazonium salt.

11. The interconnect device of claim 5 in which the device includes at least two contacts with mating surfaces, and at least one of the two mating surfaces is coated with the molecular contact coating.

12. The interconnect device of claim 5 in which the device includes at least two contacts with mating surfaces, and both mating surfaces are coated with the molecular contact coating.

13. The interconnect device of claim 5 in which the repeat units are interspersed in a regular or random fashion with non-surface bonding repeat units such as CH₂CH₂ or CH(C₆H)CH₂ (in 1-7,9 and 11-14), and Si(CH₃)₂O in (10).

14. The interconnect device of claim 5 in which the dimensions of the interconnect are in the micron-sized regime.

15. The interconnect device of claim 5 in which the dimensions of the interconnect are in the nano-sized regime.

16. The interconnect device of claim 5 in which the interconnect is a pin interconnect.

17. An electrical interconnect device having at least one electrically conducting metal contact, the improvement comprising:
applying to the surface of the contact a molecular contact coating comprising oligo(phenyleneethynylene) compounds of the following type: 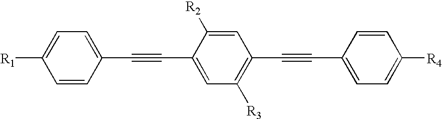
where R₁ and/or R₄ are metal binding ligands and R₂ and/or R₃ are redox active groups.

18. The electrical interconnect device of claim 17 in which R₁ and/or R₄ are thiol, pyridine, pyrazine, nitrile, diazonium salt, isonitrile or amine.

19. The electrical interconnect device of claim 17 in which R₂ and/or R₃ are nitro groups or H or alkyl groups.

20. The interconnect device of claim 15 comprising oligo(phenyleneethynylene) compounds chosen from the group consisting of: 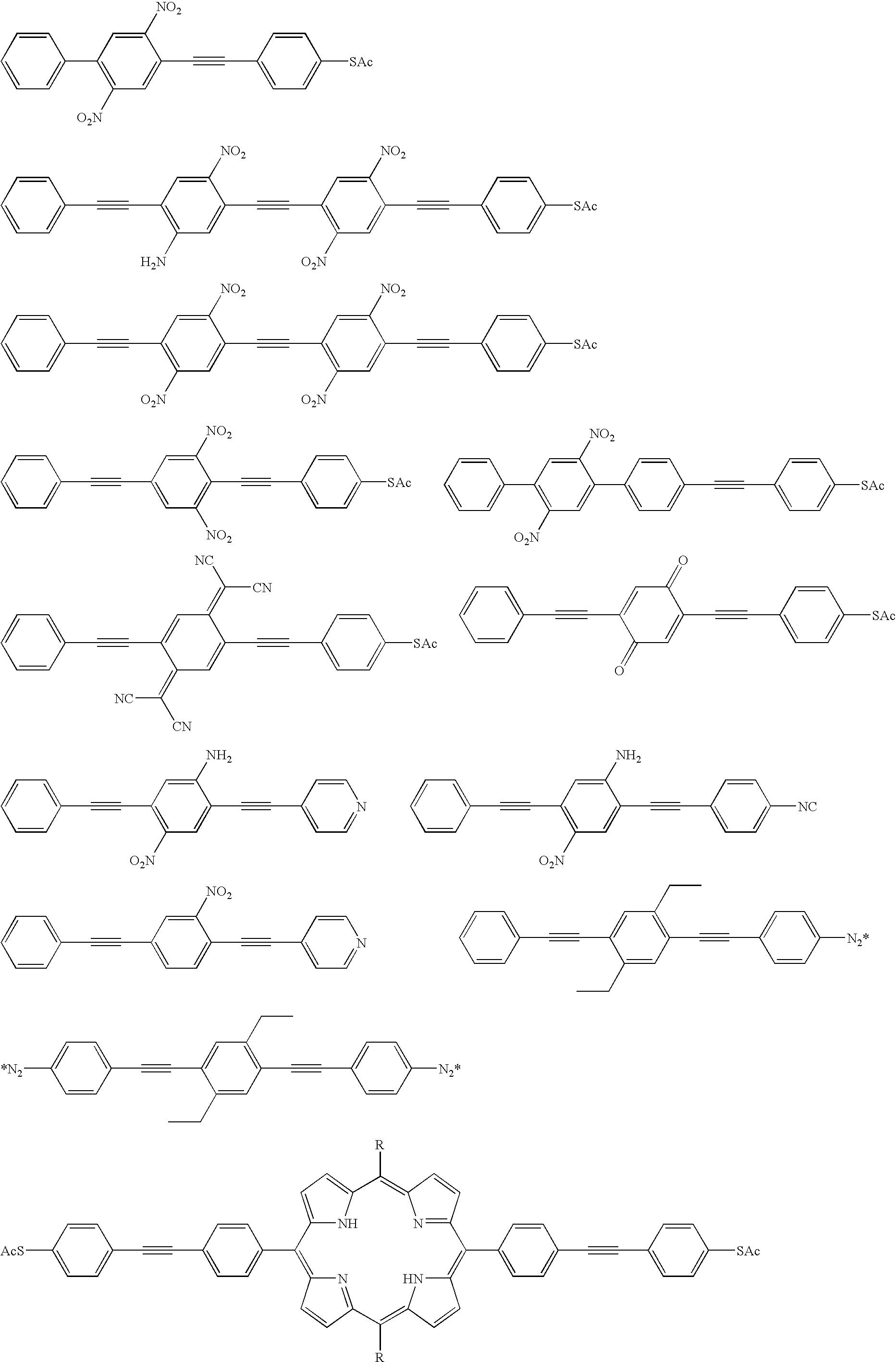
where R=C₆H₅, R=p-C₆H₄—CH₃, p-C₆H₄—Br, or R=p-C₆H₄—I.

21. The interconnect device of claim 17 whereby the interconnect has at least two mating contact surfaces, and a molecular contact layer is provided negative differential resistance, whereby an “active” connection is provided between the two mating contacts, with conductivity limited to a defined voltage region.

22. The interconnect device of claim 17 whereby the interconnect has at least two mating contact surfaces, and a diodic molecular contact layer is provided.

23. The interconnect device of claim 17 whereby the interconnect has at least two mating contact surfaces, and a switch-like molecular contact layer is provided.

24. In an electrical interconnect device having at least one electrically conducting metal contact, the improvement comprising:
applying to the surface of the contact a molecular contact coating comprising a pi-conjugated compound chosen from the group consisting of, oligo(phenyleneethenylene)s, oligo(thiophenyleethenylene)s, oligo(arylene)s, oligo(arylenylethenylene)s and oligo(arylenylethynylene)s.

25. The interconnect device of claim 24 in which semiconducting nanoparticles or metallic nanoparticles or nanorods bind to the non-surface-binding termini of the molecule chosen.

26. The interconnect device of claim 24 in which metallic nanorods, semiconducting nanorods, carbon nanotubes that are single-walled or multi-walled, or C₆₀ bind to the non-surface-binding termini of the molecule chosen.

27. The interconnect device of claim 25 in which metallic nanoparticles are used and the nanoparticles are gold nanoparticles.

28. The interconnect device of claim 26 in which metallic nanorods are used and the nanorods are gold nanorods.

29. In an electrical interconnect device having at least one electrically conducting metal contact, the improvement comprising:
applying to the surface of the contact a molecular contact coating comprising a mat of single-walled or multi-walled carbon nanotubes or chemically modified single-walled or multi-walled carbon nanotubes.

30. The interconnect device of claim 29 in which the carbon nanotubes are single-walled or multi-walled carbon nanotubes as follows: 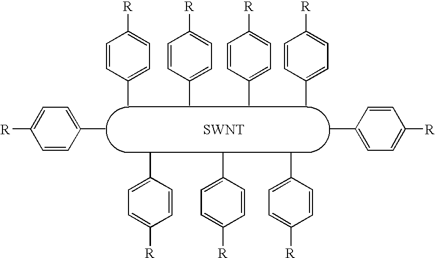
where R is —COOH, —OH, —NO₂, or —SH.

31. The interconnect device of claim 30 in which the nanotubes are oxidized to expose carboxylic acid groups and selectively functionalized at the exposed carboxylic acid groups with —COOH, —OH, —NO₂, or —SH.

32. The interconnect device of claim 1 in which the contact surface is chosen from the group consisting of gold, palladium, platinum, copper, nickel, copper/zinc, copper/beryllium, silver and alloys therefrom.

33. The interconnect device of claim 1 in which binding groups are present from the group consisting of thiol, thioacetate (precursor to thiol), nitrile, amine, isonitrile, heterocycle, or diazonium salt.

34. The interconnect device of claim 6 in which the contact is made of a metal or alloy chosen from the group consisting of gold, palladium, platinum, copper, nickel, copper/zinc, and copper/beryllium, silver, and alloys therefrom.

35. The interconnect device of claim 5 in which binding groups are present from the group consisting of thiol, thioacetate (precursor to thiol), nitrile, amine, isonitrile, heterocycle, or diazonium salt.

36. A method of modifying the surface of an electrical contact to improve its resistance to failure due to oxidation and other reactions with chemical agents, to reduce its surface roughness, to improve its lubricity, to improve its conductivity, and to stabilize the contact surface from molecular reconstruction comprising coating the contact surface with a molecular contact coating chosen from the group consisting of monomers, oligomers, or polymers that are organic in origin, capable of forming self-assembled monolayers or self-assembled multilayers, electrically conducting or non-conducting, and contain metal-binding ligands as pendant groups or as part of their backbone.

37. A method of maintaining protection from oxidation and other reactions of mating electrical contact surfaces comprising:
coating at least one of the contact surfaces with a molecular contact coating chosen from the group consisting of monomers, oligomers, or polymers that are organic in origin, capable of forming self-assembled monolayers or self-assembled multilayers, electrically conducting or non-conducting, and contain metal-binding ligands as pendant groups or as part of their backbone;
mating the contacts and pushing the molecular contact coating away from corresponding portions of the coated contact surfaces so that uncoated portions of the contacts can touch at those corresponding contact portions; and
separating the contacts to expose the molecular contact coating to permit molecules in the remaining areas of the molecular contact coating to migrate to and fill the exposed areas.

38. The interconnect device of claim 5 in which repeat units are interspersed in a regular or random fashion with non-surface bonding repeat units.
